(19) United States
(12) Patent Application Publication
(10) Pub. No.: US 2026/0343626 A1
(43) Pub. Date: Oct. 29, 2026

(54) RESOURCE DETERMINING METHOD AND APPARATUS, DEVICE, AND STORAGE MEDIUM

(71) Applicant: VIVO MOBILE COMMUNICATION CO., LTD., Dongguan (CN)

(72) Inventors: Zhi LU, Dongguan (CN); Xiaodong YANG, Dongguan (CN); Zhipeng LIN, Dongguan (CN); Xiaohang CHEN, Dongguan (CN)

(73) Assignee: VIVO MOBILE COMMUNICATION CO., LTD., Dongguan (CN)

(21) Appl. No.: 19/713,668

(22) Filed: Jun. 18, 2026

Related U.S. Application Data
(63) Continuation of application No. PCT/CN2024/141536, filed on Dec. 23, 2024.

(30) Foreign Application Priority Data
Dec. 28, 2023 (CN) 202311842095.7

(51) Int. Cl. H04W 74/0833; H04W 72/0446; H04W 74/00; H04W 74/08

(52) U.S. Cl. CPC H04W 74/0833; H04W 72/0446; H04W 74/002; H04W 74/0891

(57) ABSTRACT

A resource determining method and apparatus, a device, and a storage medium are provided. The resource determining method includes: receiving, by a terminal, first control information from a network side device, where the first control information includes first information, the first information is used to determine a first random access channel occasion (RO) type, and the first RO type includes a resource configuration type of an RO; performing, by the terminal, initiation on a random access process based on the first RO type.

### CROSS-REFERENCE TO RELATED APPLICATIONS

This application is a continuation of International Application No. PCT/CN2024/141536, filed Dec. 23, 2024, which claims priority to Chinese Patent Application No. 202311842095.7, filed Dec. 28, 2023. The entire contents of each of the above-referenced applications are expressly incorporated herein by reference.

### TECHNICAL FIELD

This application relates to the field of communication technologies, and specifically, to a resource determining method and apparatus, a device, and a storage medium.

### BACKGROUND

In a communication system, a terminal may connect to a network through a random access process. The random access process may include a four-step random access process (alternatively referred to as a type-1 random access process) and a two-step random access process (alternatively referred to as a type-2 random access process). The four-step random access process is used as an example. The terminal may send a Msg1 to a network side, where the Msg1 includes a random access preamble, so that the network side sends a Msg2 after detecting the random access preamble. The Msg2 includes an uplink resource allocated to the terminal for sending a Msg3. In this case, the terminal sends the Msg3 based on the uplink resource. Therefore, after receiving a Msg4 sent by the network side, four-step random access is completed.

In some embodiments, initiation on random access may be performed by triggering the terminal by a network side. For example, when it is found through measurement on the network side that uplink out-of-synchronization occurs or an uplink service is not sent for a long time, the network side may trigger the terminal to perform re-initiation on a random access process. In some embodiments, the network side may send a Physical Downlink Control Channel (PDCCH) order to the terminal, to trigger the terminal to send the random access preamble. However, after the terminal receives the PDCCH order, how to determine a resource for sending the random access preamble currently has no solution. Therefore, transmission reliability and a resource utilization rate cannot be ensured.

### SUMMARY

Embodiments of this application provide a resource determining method and apparatus, a device, and a storage medium.

According to a first aspect, a resource determining method is provided. The method includes: receiving, by a terminal, first control information from a network side device, where the first control information includes first information, the first information is used to determine a first Random Access Channel Occasion (RO) type, and the first RO type includes a resource configuration type of an RO; and performing, by the terminal, initiation on a random access process or repeated transmission on a preamble based on the first RO type.

According to a second aspect, a resource determining method is provided. The method includes: sending, by a network side device, first control information to a terminal, where the first control information includes first information, the first information is used to determine a first RO type, the first RO type includes a resource configuration type of an RO, and the first RO type is used to perform initiation on a random access process or repeated transmission on a preamble.

According to a third aspect, a resource determining apparatus is provided. The apparatus includes: a receiving module and an execution module. The receiving module is configured to receive first control information from a network side device, where the first control information includes first information, the first information is used to determine a first RO type, and the first RO type includes a resource configuration type of an RO. The execution module is configured to perform initiation on a random access process or repeated transmission on a preamble based on the first RO type.

According to a fourth aspect, a resource determining apparatus is provided. The apparatus includes a sending module. The sending module is configured to send first control information to a terminal, where the first control information includes first information, the first information is used to determine a first RO type, the first RO type includes a resource configuration type of an RO, and the first RO type is used to perform initiation on a random access process or repeated transmission on a preamble.

According to a fifth aspect, a terminal is provided, where the terminal includes a processor and a memory, the memory stores a program or instructions runnable on the processor, and the program or the instructions, when executed by the processor, implement the steps of the method according to the first aspect.

According to a sixth aspect, a terminal is provided, including a processor and a communication interface, where the communication interface is configured to receive first control information from a network side device, the first control information includes first information, the first information is used to determine a first RO type, and the first RO type includes a resource configuration type of an RO. The processor is configured to perform initiation on a random access process or repeated transmission on a preamble based on the first RO type.

According to a seventh aspect, a network side device is provided, where the network side device includes a processor and a memory, the memory stores a program or instructions runnable on the processor, and the program or the instructions, when executed by the processor, implement the steps of the method according to the second aspect.

According to an eighth aspect, a network side device is provided, including a processor and a communication interface, where the communication interface is configured to send first control information to a terminal, the first control information includes first information, the first information is used to determine a first RO type, the first RO type includes a resource configuration type of an RO, and the first RO type is used to perform initiation on a random access process or repeated transmission on a preamble.

According to a ninth aspect, a readable storage medium is provided. The readable storage medium stores a program or instructions. The program or instructions, when executed by a processor, implement the steps of the method according to the first aspect, or the steps of the method according to the second aspect.

According to a tenth aspect, a wireless communication system is provided, including a terminal and a network side device. The terminal may be configured to perform the steps of the method according to the first aspect. The network side device may be configured to perform the steps of the method according to the second aspect.

According to an eleventh aspect, a chip is provided, where the chip includes a processor and a communication interface, the communication interface is coupled to the processor, and the processor is configured to run a program or instructions, to implement the method according to the first aspect or the second aspect.

According to a twelfth aspect, a computer program/program product is provided. The computer program/program product is stored in a storage medium. The program/program product is executed by at least one processor, to implement the steps of the resource determining method according to the first aspect or the steps of the resource determining method according to the second aspect.

In the embodiments of this application, the terminal receives the first control information from the network side device, where the first control information includes the first information, and the first information is used to determine the RO type used to perform initiation on the random access process or repeated transmission on the preamble. The terminal performs initiation on the random access process or repeated transmission on the preamble based on the first RO type. In this solution, the terminal may determine, based on the first information in the first control information, the RO type used to perform initiation on the random access process or repeated transmission on the preamble. That is, the first control information may explicitly or implicitly indicate the RO type, so that the terminal learns the specific RO type used when initiation on the random access process is performed or repeated transmission on the preamble is performed, thereby ensuring reliability and a resource utilization rate of the terminal performing initiation on the random access process or repeated transmission on the preamble.

### BRIEF DESCRIPTION OF THE DRAWINGS

FIG. 1 is a schematic diagram of an architecture of a wireless communication system according to an embodiment of this application;

FIG. 2 is a flowchart 1 of a resource determining method according to an embodiment of this application;

FIG. 3 is an example diagram 1 of mapping between an SSB and an RO type according to an embodiment of this application;

FIG. 4a and FIG. 4b are example diagrams of a full-duplex mode according to an embodiment of this application;

FIG. 5 is a flowchart 2 of a resource determining method according to an embodiment of this application;

FIG. 6 is a flowchart 3 of a resource determining method according to an embodiment of this application;

FIG. 7 is an example diagram of a relationship between a time interval and an RO type according to an embodiment of this application;

FIG. 8 is a flowchart 4 of a resource determining method according to an embodiment of this application;

FIG. 9 is an example diagram of an RO type for repeated transmission according to an embodiment of this application;

FIG. 10 is a flowchart 5 of a resource determining method according to an embodiment of this application;

FIG. 11 is a flowchart 6 of a resource determining method according to an embodiment of this application;

FIG. 12 is an example diagram 2 of mapping between an SSB and an RO type according to an embodiment of this application;

FIG. 13 is an example diagram of an RO resource configuration case according to an embodiment of this application;

FIG. 14 is an example diagram of an RO in a frequency domain unit according to an embodiment of this application;

FIG. 15a and FIG. 15b are example diagrams of an RO in a RAT according to an embodiment of this application;

FIG. 16 is an example diagram of an RO in a TAG according to an embodiment of this application;

FIG. 17 is a schematic diagram 1 of a structure of a resource determining apparatus according to an embodiment of this application;

FIG. 18 is a schematic diagram 2 of a structure of a resource determining apparatus according to an embodiment of this application;

FIG. 19 is a schematic diagram of a hardware structure of a communication device according to an embodiment of this application;

FIG. 20 is a schematic diagram of a hardware structure of a terminal according to an embodiment of this application; and

FIG. 21 is a schematic diagram of a hardware structure of a network side device according to an embodiment of this application.

### DETAILED DESCRIPTION

Technical solutions in embodiments of this application are clearly described in the following with reference to the accompanying drawings in the embodiments of this application. Apparently, the described embodiments are some rather than all of the embodiments of this application. All other embodiments obtained by a person of ordinary skill in the art based on the embodiments of this application shall fall within the protection scope of this application.

The terms “first”, “second”, and the like in this application are used to distinguish similar objects, but are not used to describe a specific sequence or order. It should be understood that terms used in this way are interchangeable in appropriate circumstances, so that embodiments of this application can be implemented in other orders than the order illustrated or described herein. In addition, objects distinguished by “first” and “second” are usually objects of one class with the number of objects unlimited. For example, a first object can indicate one or more first objects. In addition, the term “or” in the present application denotes at least one of the connected objects. For example, “A or B” covers three schemes, that is, a scheme 1: including A and excluding B; a scheme 2: B is included and A is not included; and a scheme 3: both A and B are included. The character “/” generally indicates an “or” relationship between the associated objects.

In this application, the term “indication” may be a direct indication (or referred to as an explicit indication) or an indirect indication (or referred to as an implicit indication). The direct indication may be understood as that a sending party explicitly notifies a receiving party of content such as specific information, an operation that needs to be performed, or a request result in the sent indication. The indirect indication may be understood as that the receiving party determines corresponding information based on an indication sent by the sending party, or performs determining and determines an operation that needs to be performed or a request result based on a determining result.

The terms “at least one (item)”, “at least one of”, and the like in this application refer to any one, any two, or a combination of two or more of the objects included thereof. For example, at least one (item) of a, b, or c may represent “a”, “b”, “c”, “a and b”, “a and c”, “b and c”, and “a, b, and c”, where a, b, and c may be one or more. Similarly, “at least two (items)” means two or more, and the expressed meaning thereof is similar to that of “at least one (item)”.

It should be noted that the technologies described in the embodiments of this application are not limited to a Long Term Evolution (LTE)/LTE-advanced (LTE-A) system, and may also be used in another wireless communication system, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or another system. The terms “system” and “network” in the embodiments of this application are often used interchangeably, and the described technology can be applied to the systems and radio technologies mentioned above, and can be also applied to other systems and radio technologies. The following descriptions describe a New Radio (NR) system for exemplary purposes and use the term NR for much of the following descriptions. However, these technologies may also be used in systems other than the NR system, such as a 6th Generation (6G) communication system.

FIG. 1 is a block diagram of a wireless communication system to which the embodiments of this application are applicable. The wireless communication system includes a terminal 11 and a network side device 12. The terminal 11 may be a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), Augmented Reality (AR), a Virtual Reality (VR) device, a robot, a wearable device, a flight vehicle, Vehicle User Equipment (VUE), a ship-borne device, Pedestrian User Equipment (PUE), a smart home appliance (a home device having a wireless communication function, such as a refrigerator, a television, a washing machine, or furniture), and terminal side devices such as a game machine, a Personal Computer (PC), a teller machine, or a self-service machine. The wearable device includes a smart watch, a smart band, a smart earphone, smart glasses, smart jewelry (a smart bracelet, a smart chain, a smart ring, a smart necklace, a smart anklet, a smart ankle chain, or the like), a smart wristband, smart clothing, or the like. The vehicle user equipment may also be referred to as a vehicle terminal, a vehicle controller, a vehicle module, a vehicle component, a vehicle chip, a vehicle unit, or the like. It should be noted that, a specific type of the terminal 11 is not limited in the embodiments of this application. The network side device 12 may include an access network device or a core network device, where the access network device may alternatively be referred to as a Radio Access Network (RAN) device, a radio access network function, or a radio access network unit. The access network device may include a base station, a Wireless Local Area Network (WLAN) Access Point (AP), a Wireless Fidelity (Wi-Fi) node, or the like. The base station may be referred to as a NodeB (NB), an Evolved NodeB (eNB), a next generation NodeB (gNB), a new radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a transmission and reception point (TRP), or another appropriate term in the field. Provided that the same technical effect is achieved, the base station is not limited to specific technical terms. It should be noted that, in the embodiments of this application, only a base station in an NR system is used as an example for description, but a specific type of the base station is not limited.

Some concepts and/or terms used in a resource determining method and apparatus, a device, and a storage medium provided in the embodiments of this application are explained below.

### 1. Selection of a Random Access Resource

In existing technology, a random access process may be a contention-based random access process or a contention-free random access process. The random access process may be a four-step random access process (alternatively referred to as a type-1 random access process) or a two-step random access process (alternatively referred to as a type-2 random access process).

In a contention-based four-step random access process, a terminal first sends a Msg1 to a network, where the Msg1 includes a preamble. After detecting the preamble, the network sends a Msg2 or a Random Access Response (RAR) message, including a serial number of the preamble detected by the network and an uplink radio resource allocated to the terminal for sending a Msg3. After receiving the Msg2, the terminal determines that at least one serial number in the serial number of the preamble carried in the Msg2 is the same as a serial number of a preamble sent by the terminal, and then sends, based on the resource indicated by an RAR, the Msg3 including contention resolution information. After receiving the Msg3, the network sends a Msg4 including contention resolution information. The terminal receives the Msg4, and determines that the contention resolution information is the same as that sent by the terminal in the Msg3, to complete four-step random access.

The network includes uplink grant (UL grant) information in the RAR to indicate scheduling information of a Msg3 Physical Uplink Shared Channel (PUSCH), and also includes a Random Access Channel Preamble ID (RAPID), a Temporary Cell-Radio Network Temporary Identifier (TC-RNTI), TA, and the like. If the network receives no Msg3 PUSCH, the network may schedule repeated transmission of the Msg3 PUSCH on a PDCCH scrambled by using the TC-RNTI.

For the contention-based random access process, different terminals randomly select a preamble for transmission. In this way, the different terminals may select a same preamble on a same time-frequency radio resource (RO resource) for transmission. This may be understood as a preamble conflict between the terminals. In this case, the different terminals receive a same RAR, and the different terminals transmit the Msg3 PUSCH based on scheduling information in an RAR UL grant. Because the existing technology does not support repeated transmission of the Msg3 PUSCH, and the network can resolve, on one Msg3 PUSCH scheduling resource, a PUSCH (including contention-based resolution information) sent by only one terminal, the network includes, in the Msg4, contention-based resolution information received in the Msg3. If the contention-based resolution information received by the terminal in the Msg4 matches the contention-based resolution information sent by the terminal on the Msg3 PUSCH, the terminal considers that contention is resolved successfully. If the contention-based resolution information received by the terminal in the Msg4 does not match the information sent by the terminal on the Msg3 PUSCH, it is considered that the contention is resolved unsuccessfully.

If the contention is resolved unsuccessfully, the terminal reselects a Random Access Channel (RACH) sending resource to send a Physical Random Access Channel (PRACH) for a next random access attempt.

In NR Rel-16, a two-step random access process and a 2-step RACH are introduced. First, the terminal sends a MsgA to a network side. After receiving the MsgA, the network side sends a MsgB to the terminal. If the terminal receives no MsgB within a time period, the terminal increments a counter for counting a quantity of MsgA sending times and resends the MsgA. If the counter for counting the quantity of MsgA sending times reaches a threshold, the terminal may switch from the 2-step random access process to the 4-step random access process. The MsgA includes a MsgA preamble part and a MsgA PUSCH part. The preamble part is sent on an RO for the 2-step RACH, and the PUSCH part is sent on a MsgA PUSCH resource associated with sending of the MsgA preamble and the RO. MsgA PUSCH resources are a group of PUSCH resources configured for each PRACH slot, including a time-frequency resource and a Demodulation Reference Signal (DMRS) resource.

### 2. Selection of a Random Access Resource and Mapping of a Synchronization Signal Block (SSB) to an RO

In NR, a cell may configure a plurality of Frequency Division Multiplexing (FDM) physical random access channel transmission occasions (PRACH transmission occasion, or referred to as a PRACH occasion, that is, a physical random access channel occasion) at a time domain position for transmitting a PRACH. The physical random access channel transmission occasion is referred to as an RO for short. At a moment, a quantity of ROs on which FDM may be performed may be {1, 2, 4, 8}.

The random access preamble can be transmitted only on a time domain resource (that is, an RO resource) configured based on a higher-layer parameter PRACHConfigurationIndex, and can be transmitted only on a frequency domain resource configured based on a higher-layer parameter prach-FDM n_{RA}=∈{0, 1, . . . , M−1}, where M is the higher-layer parameter prach-FDM. During initial access, PRACH frequency domain resources are numbered in ascending order from an RO resource at a lowest frequency on an initial active uplink bandwidth part (initial active uplink bandwidth part); otherwise, the PRACH frequency domain resources are numbered in ascending order from an RO resource at a lowest frequency on an active uplink bandwidth part.

In NR, there is an association relationship between the RO and an actually sent Synchronization Signal (SS)/Physical Broadcast Channel (PBCH) block (that is, an SSB). One SSB may be associated with a plurality of ROs, or a plurality of SSBs may be associated with one RO (in this case, different SSBs correspond to different preambles). Usually, a base station may send different SSBs by using different beams, and a corresponding terminal sends a preamble on an RO associated with an SSB. In this way, the terminal selects, based on Reference Signal Receiving Power (RSRP) strength of the received SSB, an RO or a combination RO+preamble associated with an SSB having good RSRP strength, to send the preamble. In this way, the network may determine, based on the RO or the combination RO+preamble of the received preamble, an SSB selected by the terminal. In addition, the network sends a Msg2 on a downlink beam corresponding to the SSB, to ensure reception quality of a downlink signal.

### 3. a Time Domain Resource Position (Such as a Period or an RO) of a PRACH

A PRACH resource is a periodic resource. In a time domain, different PRACH preamble formats have different duration. A time domain position of the PRACH resource is defined by using a PRACH configuration period, a radio frame index, a subframe index or a slot index, an initial PRACH Orthogonal Frequency Division Multiplexing (OFDM) symbol index in a slot, and a quantity of time domain ROs in the slot. Candidate values of PRACH configuration periods are {10, 20, 40, 80, 160} ms. In each of the PDCCH configuration periods, a PDCCH resource is distributed in only one effective radio frame (10 ms). The effective radio frame includes one or more subframes or slots. There is only one initial PRACH OFDM symbol index in each subframe or slot. One slot has one or more time domain ROs. In a frequency domain, different PRACH preamble formats and sub-carrier spacings jointly determine a frequency-domain bandwidth occupied by the PRACH. For a long preamble format with a length of 839, when a PRACH sub-carrier spacing is 1.25 kHz, a frequency-domain bandwidth is 1.08 MHz, and corresponds to six Physical Resource Block (PRB) with a PUSCH sub-carrier spacing of 15 kHz.

### 4. PDCCH Order

The base station informs, by using a special Downlink Control Information (DCI) format 1_0, the terminal that re-initiation on a random access process needs to be performed, and informs the terminal of an RA-PreambleIndex, an SSB Index, and a PRACH mask index (Mask Index) that should be used, and an indication of whether an uplink or a sidelink (Sidelink, which may alternatively be referred to as a side link or a lateral link).

A resource determining method provided in the embodiments of this application is described in detail below through some embodiments and application scenarios thereof with reference to the accompanying drawings.

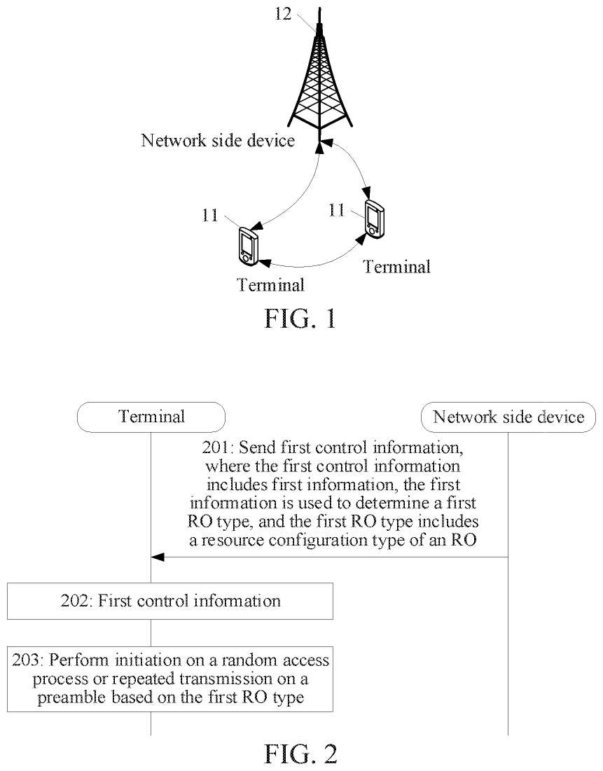

An embodiment of this application provides a resource determining method. FIG. 2 is a flowchart of a resource determining method according to an embodiment of this application. As shown in FIG. 2, the resource determining method provided in this embodiment of this application may include the following step 201 to step 203.

Step 201: A network side device sends first control information to a terminal.

Step 202: The terminal receives first control information from the network side device.

In this embodiment of this application, the first control information includes first information, the first information is used to determine a first RO type, and the first RO type includes a resource configuration type of an RO.

In this embodiment of this application, the first control information may be DCI carrying a PDCCH order. The PDCCH order is used to instruct to perform initiation on a random access process or repeated transmission on a preamble (that is, perform repeated transmission on a random access preamble).

It should be noted that, performing repeated transmission on the preamble may be understood as that the terminal repeatedly sends a random access message (such as a Msg1 or a MsgA), and the random access message sent each time includes a random access preamble, that is, before receiving a random access response (such as a Msg2 or a MsgB), the terminal completes repeated transmission of the random access preamble.

In this embodiment of this application, the PDCCH order includes at least one of the following: a random access preamble index, a synchronization signal index, or a random access mask index.

It should be noted that, in this embodiment of this application, the RO is a time-frequency resource required for sending a random access sequence. The RO type includes the resource configuration type of the RO that is used to perform initiation on the random access process or repeated transmission on the preamble. The RO type refers to an RO resource of a specific type on which the terminal performs initiation on the random access process or repeated transmission on the preamble.

In this embodiment of this application, the RO type is any one of the following: an RO resource on an uplink sub-band, an RO resource in an uplink time domain unit, an RO resource in a flexible time domain unit, or an RO resource spanning a plurality of resources. For example, the RO resource spanning a plurality of resources is an RO resource occupying both an uplink sub-band and an uplink time domain unit.

In this embodiment of this application, the foregoing uplink time domain unit may be a time domain unit for which no sub-band is configured.

In this embodiment of this application, the flexible time domain unit may be any one of the following:
(1) a flexible time domain unit configured with no uplink direction or downlink direction, where a network may configure the flexible time domain unit to be an effective resource for transmitting an RO;
(2) a flexible time domain unit configured only with an uplink sub-band, or configured with both an uplink sub-band and a downlink sub-band, where a network may configure the uplink sub-band of the flexible time domain unit to be an effective resource for transmitting an RO; or
(3) a flexible time domain unit configured only with a downlink sub-band, where a network may configure a resource other than the downlink sub-band and a guard band of the flexible time domain unit to be an effective resource for transmitting an RO.

In this embodiment of this application, the time domain unit may be a radio frame, a subframe, a slot, a mini slot, a symbol, or the like.

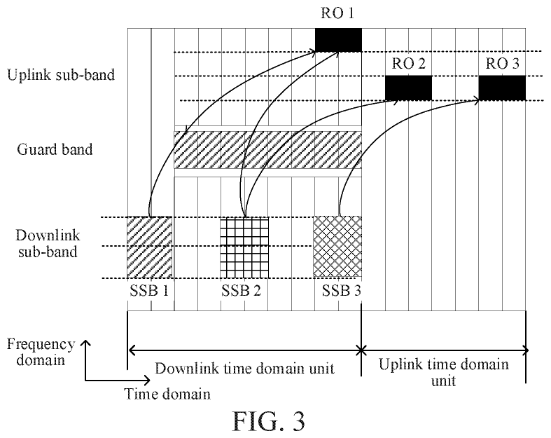

For example, as shown in FIG. 3, a synchronization signal (for example, an SSB 1) may be mapped to the RO resource on the uplink sub-band. An SSB 3 may be mapped to the RO resource in the uplink time domain unit. An SSB 2 may be mapped to both the RO resource on the uplink sub-band and the RO resource in the uplink time domain unit. The RO resource in the figure may include a plurality of ROs.

It should be noted that, the synchronization signal in this embodiment of this application may be an SSB, or may be a module including at least one of the following: a broadcast channel, a broadcast signal, another system message, or the like. The SSB and the SS/PBCH block may be used interchangeably, or may have other names. In this embodiment of this application, mapping between the synchronization signal and the RO may be a generalized association between a downlink signal and an uplink signal or an uplink resource, for example, an association relationship between a Channel State Information-Reference Signal (CSI-RS) and an RO.

In this embodiment of this application, to simplify descriptions, an uplink sub-band (located in a downlink time unit, an uplink time unit, or a flexible time unit) and an uplink time unit (no sub-band is configured) are emphasized. Resource types and combinations of other ROs are not excluded.

This embodiment of this application may be applied to a flexible time unit, including: a flexible time unit configured with no sub-band, a flexible time unit configured only with an uplink sub-band, a flexible time unit configured only with a downlink sub-band, and a flexible time unit configured with both an uplink sub-band and a downlink sub-band.

This embodiment of this application supports augmented duplex, which may be referred to as an augmented duplex mode, an XDD, augmented full duplex, or an augmented full duplex mode. That is, in this embodiment of this application, the uplink sub-band is supported in the downlink time unit, the downlink sub-band is supported in the uplink time unit, or at least one of uplink sub-band transmission or downlink sub-band transmission is supported in the flexible time unit.

The augmented duplex may include network full duplex and terminal full duplex. Network full duplex: Full duplex is applied to a network side, and half duplex is applied to a UE side. Terminal full duplex: Full duplex is applied to the network side, and full duplex is applied to the UE side. The full duplex on the UE side simultaneously receives a downlink signal and sends an uplink signal in one time unit.

The network full duplex mode may achieve objectives of enhancing coverage, reducing a transmission delay, and improving resource utilization efficiency. The terminal full duplex mode may improve a downlink throughput or an uplink throughput while obtaining the foregoing gain. Usually, a guard band needs to be reserved between uplink transmission and downlink transmission. For example, a guard band is reserved to achieve frequency isolation and reduce self-interference. Usually, a self-interference cancellation capability of the terminal is weaker than that of the network side. For simultaneous receiving and sending on the terminal side, a guard band needing to be reserved is larger than that on the network side, that is, more reserved PRBs are required as a guard band.

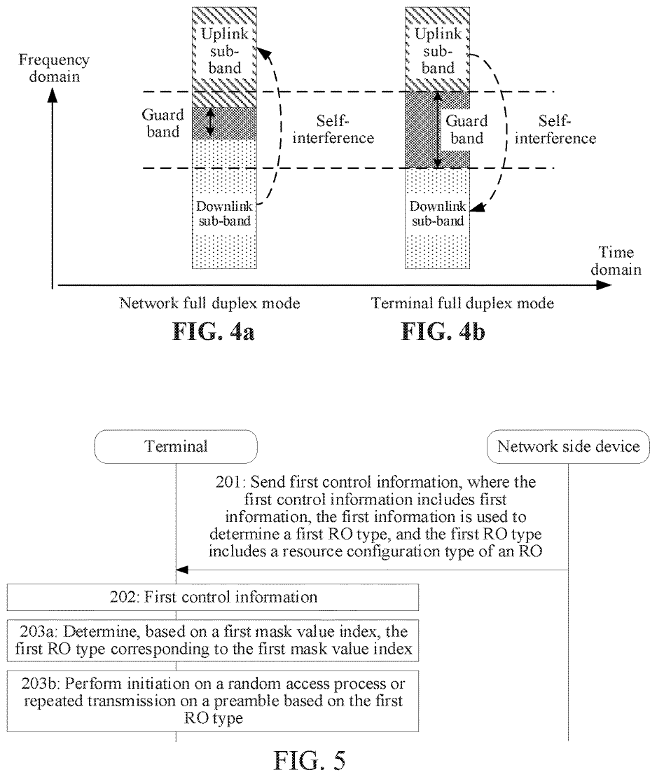

FIG. 4a shows a full duplex sub-band and guard band configuration on the network side, that is, the network configures time-frequency resources on an uplink sub-band and a downlink sub-band (or a guard band). On the uplink sub-band, the network receives an uplink channel or signal of a served terminal, and on the downlink sub-band, the network sends a downlink signal to the served terminal. Downlink sending may cause self-interference to uplink reception. FIG. 4b shows full duplex sub-band configuration on a terminal side. The network configures time-frequency resources on an uplink sub-band and a downlink sub-band (or a guard band) for a terminal, and uplink sending of the terminal may cause self-interference to downlink reception. Different terminals may have different capabilities, and therefore, may have different guard bands that need to be reserved.

Step 203: The terminal performs initiation on a random access process or repeated transmission on a preamble based on the first RO type.

In this embodiment of this application, the first information includes a first mask value index. With reference to FIG. 2, as shown in FIG. 5, step 203 may be implemented through the following step 203a and step 203b.

Step 203a: The terminal determines, based on the first mask value index, the first RO type corresponding to the first mask value index.

In this embodiment of this application, each mask value index corresponds to one RO type or one group of RO types.

Step 203b: The terminal performs initiation on the random access process or repeated transmission on the preamble based on the first RO type.

In this embodiment of this application, each mask value index corresponds to one RO type, that is, the first RO type is one RO type corresponding to the first mask value index, and the first RO type is used by the terminal to perform initiation on the random access process.

In this embodiment of this application, each mask value index corresponds to one group of RO types, that is, the first RO type is one group of RO types corresponding to the first mask value index, and the first RO type is used by the terminal to perform repeated transmission on the preamble. The group of RO types includes at least one RO type.

In this embodiment of this application, the one group of RO types includes at least one of the following: an RO resource on an uplink sub-band or an RO resource in a first time domain unit. The first time domain unit is an uplink time domain unit or a flexible time domain unit.

In this embodiment of this application, the terminal may determine, from a first table based on the first mask value index, the first RO type corresponding to the first mask value index. The first table includes a column of at least one mask value index and a column of at least one RO type, and each mask value index corresponds to one RO type or one group of RO types.

In this embodiment of this application, the at least one RO type may be indicated by setting a column in a table. For example, a column indicating an RO type is set in the first table. In some embodiments, the at least one RO type may be indicated by setting a row in a table. For example, a row indicating an RO type is set in the first table.

It should be noted that, for a Contention-Based Random Access (CBRA) or a Contention-Free Random Access (CFRA) triggered by the PDCCH order, the RO type may be determined by adding, to the first table, the column indicating the RO type, or by using the row in the first table.

In this embodiment of this application, more mask value indexes may be added to the first table, so that each of the mask value indexes has a corresponding RO type indication (more bits are required).

In this embodiment of this application, the foregoing first mask value index (PRACH Mask Index) may be msgA-ssb-SharedRO-MaskIndex or ssb-SharedRO-MaskIndex sent by the network side device. It should be noted that, a shared RO refers to a PRACH sequence used for a type of PRACH transmission and a PRACH sequence used for another type of PRACH transmission.

For example, in a manner, as shown in Table 1, an indication column (that is, an RO type indicator field) may be added to the first table, to indicate an RO type corresponding to a mask value index, for performing initiation on the random access process.

TABLE 1

| Mask value index | Allowed RO of an SSB | RO type |
|---|---|---|
| 0 | All ROs | Any type |
| 1 | RO index 1 | Uplink sub-band |
| 2 | RO index 2 | Uplink time domain unit |
| 3 | RO index 3 | Uplink sub-band |
| 4 | RO index 4 | Uplink time domain unit |
| 5 | RO index 5 | Uplink sub-band |
| 6 | RO index 6 | Uplink time domain unit |
| 7 | RO index 7 | Uplink sub-band |
| 8 | RO index 8 | Uplink time domain unit |
| 9 | Each RO with an even- | Uplink sub-band |
| | numbered index | |
| 10 | Each RO with an odd- | Uplink time domain unit |
| | numbered index | |
| 11 | Reserved | — |
| 12 | Reserved | — |
| 13 | Reserved | — |
| 14 | Reserved | — |
| 15 | Reserved | — |

For example, in another manner, as shown in Table 2, an existing reserved row (Reserved) in the first table is used to indicate an RO type corresponding to a mask value index, for performing initiation on a random access process. Table 2 is illustrated by using an example in which a mask value index 11 to a mask value index 15 correspond to reserved rows.

TABLE 2

| Mask value index | Allowed RO of an SSB | RO type indication |
|---|---|---|
| 0 | All ROs | — |
| 1 | RO index 1 | — |
| 2 | RO index 2 | — |
| 3 | RO index 3 | — |
| 4 | RO index 4 | — |
| 5 | RO index 5 | — |
| 6 | RO index 6 | — |
| 7 | RO index 7 | — |
| 8 | RO index 8 | — |
| 9 | Each RO with an even- | — |
| | numbered index | |
| 10 | Each RO with an odd- | — |
| | numbered index | |
| 11 | RO index 1 | Uplink sub-band |
| 12 | RO index 2 | Uplink time domain unit |
| 13 | RO index 3 | Uplink sub-band |
| 14 | RO index 4 | Uplink time domain unit |
| 15 | RO index 5 | Uplink sub-band |

For example, in still another manner, as shown in Table 3, an indication column may be added to the first table, and an existing reserved row in the first table is used, to indicate an RO type corresponding to a mask value index, for performing initiation on a random access process.

TABLE 3

| Mask value index | Allowed RO of an SSB | RO type indication |
|---|---|---|
| 0 | All ROs | Any type |
| 1 | RO index 1 | Uplink sub-band |
| 2 | RO index 2 | Uplink time domain unit |
| 3 | RO index 3 | Uplink sub-band |
| 4 | RO index 4 | Uplink time domain unit |
| 5 | RO index 5 | Uplink sub-band |
| 6 | RO index 6 | Uplink time domain unit |
| 7 | RO index 7 | Uplink time domain unit |
| 8 | RO index 8 | Uplink time domain unit |
| 9 | Each RO with an even- | Uplink time domain unit |
| | numbered index | |
| 10 | Each RO with an odd- | Uplink time domain unit |
| | numbered index | |
| 11 | RO index 1 | Uplink time domain unit |
| 12 | RO index 2 | Uplink sub-band |
| 13 | RO index 3 | Uplink time domain unit |
| 14 | RO index 4 | Uplink sub-band |
| 15 | RO index 5 | Uplink time domain unit |

It should be noted that, the foregoing Table 1 to Table 3 are illustrated by using an example in which one mask value index corresponds to one RO type. A table in which each mask value index in the foregoing first table corresponds to one group of RO types is similar to the foregoing Table 1 to Table 3, and is not further described herein again.

For example, an indication column (that is, an RO type indicator field) may be added to the first table, to indicate one group of RO types corresponding to each mask value index, that is, to indicate one group of RO types for performing repeated transmission on a preamble For example, on the RO indicated by the RO index 4, repeated transmission is performed by using an uplink time domain unit.

For repeated transmission, the network side device may configure Table 3 to include an RO type group with mixed types, as shown in the following Table 3-1. The network side device may configure that if the repeated transmission is not indicated, the terminal determines an RO type by using a first value in the RO type group; or if the repeated transmission is indicated, the terminal determines an RO type by using the RO type group. For example, on the RO indicated by the RO index 8, repeated transmission may be performed by using a mixed type in which an uplink time domain unit is first used and then an uplink sub-band is used. For another example, on the RO indicated by the RO index 14, repeated transmission may be performed by using a mixed type in which an uplink sub-band is first used and then an uplink time domain unit is used.

TABLE 3-1

| Mask | Allowed RO | |
|---|---|---|
| value index | of an SSB | RO type indication |
| . . . | | |
| 8 | RO index 8 | Uplink time domain unit and uplink |
| | | sub-band |
| . . . | | |
| 14 | RO index 4 | Uplink sub-band and uplink time |
| | | domain unit |
| . . . | | |

It should be noted that, the uplink time domain units in Table 1 to Table 3 and Table 3-1 may be flexible time domain units.

In this way, each mask value index corresponds to one RO type or one group of RO types. The terminal may determine, from the first table based on the mask value index indicated by the first control information, the RO type used to perform initiation on the random access process or repeated transmission on the preamble. That is, the first control information may implicitly indicate the RO type, to ensure reliability and a resource utilization rate of the terminal performing initiation on the random access process or repeated transmission on the preamble.

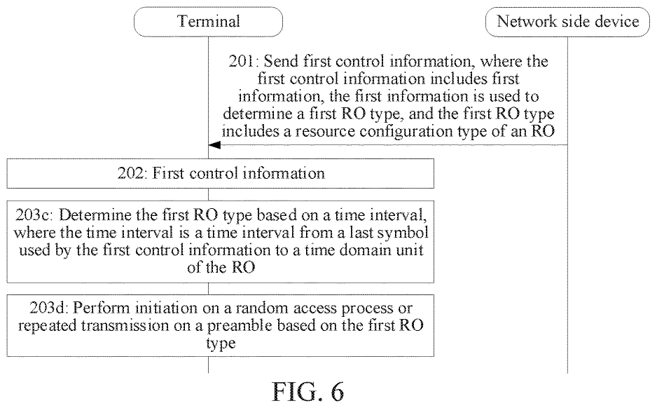

In this embodiment of this application, the first information includes a time interval. With reference to FIG. 2, as shown in FIG. 6, step 203 may be implemented by using the following step 203c and step 203d.

Step 203c: The terminal determines the first RO type based on the time interval.

Step 203d: The terminal performs initiation on the random access process or repeated transmission on the preamble based on the first RO type.

In this embodiment of this application, the time interval is a time interval from a last symbol used by the first control information to a time domain unit of the RO. A time interval range within which each time interval falls has an association relationship with the RO type.

In this embodiment of this application, a time domain unit length of the time interval may be a time domain unit length based on a sub-carrier spacing, and is represented by x bits. A specific quantity of bits and a range of the time domain unit length may be configured by the network side.

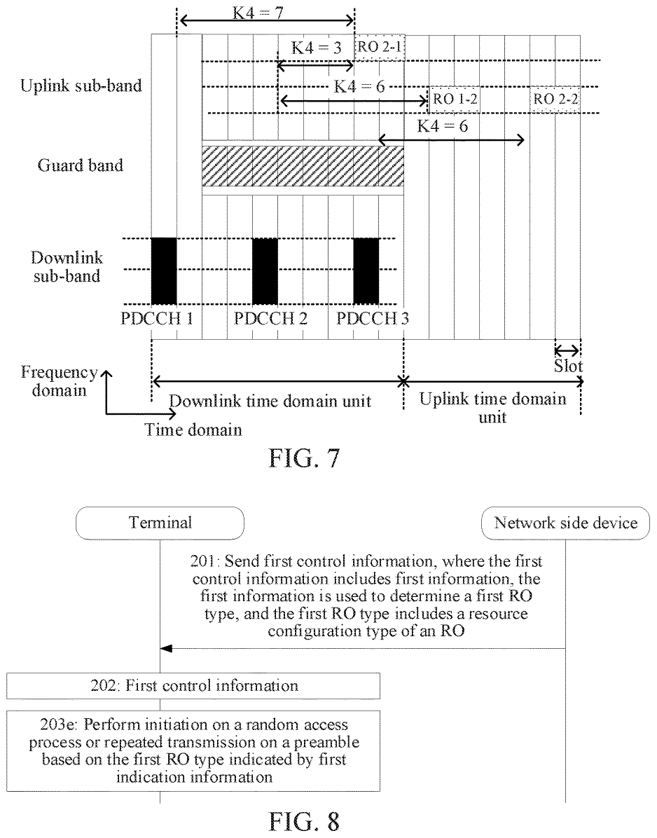

For example, as shown in FIG. 7, the time interval may be represented by k4. If a PDCCH 1 indicates k4=7 slots, the first RO type may be an RO resource on an uplink sub-band. If a PDCCH 2 indicates k4=3 slots, the first RO type may be an RO on an uplink sub-band. If a PDCCH 2 and a PDCCH 3 indicate k4=6 slots, the first RO type may be an RO resource in an uplink slot.

In this embodiment of this application, the first information further includes an initial RO symbol. Step 203c may be implemented by using the following step 203c1.

Step 203cl: In a case that one time domain unit includes a plurality of RO types, the terminal determines the first RO type based on the time interval and the initial RO symbol.

It may be understood that, when one time domain unit (a time domain unit of the RO) has both the RO on the uplink sub-band and the RO in the uplink time domain unit, the network side may additionally configure an indicator field used to indicate the initial RO symbol, to indicate a corresponding RO type. That is, one RO type is determined from the plurality of RO types included in the time domain unit as the first RO type.

In this way, the terminal may determine, based on the time interval indicated by the first control information, the RO type used to perform initiation on the random access process or repeated transmission on the preamble. That is, the first control information may implicitly indicate the RO type, to ensure reliability and a resource utilization rate of the terminal performing initiation on the random access process or repeated transmission on the preamble.

In this embodiment of this application, the foregoing first information includes first indication information. With reference to FIG. 2, as shown in FIG. 8, step 203 may be implemented by using the following step 203e.

Step 203e: The terminal performs initiation on the random access process or repeated transmission on the preamble based on the first RO type indicated by the first indication information.

In this embodiment of this application, an RO type indicator field may be added to the DCI (the first control information) carrying the PDCCH order, to explicitly indicate the first RO type. In some embodiments, a reserved bit of the DCI carrying the PDCCH order may be used to explicitly indicate the first RO type. For example, 1 bit is added, where a state 1 indicates a sub-band, and a state 0 indicates an uplink time domain unit.

In this embodiment of this application, the first RO type includes one group of RO types, and the first indication information is used to indicate one group of RO types for repeated transmission. For example, as shown in Table 4, an RO type for repeated transmission is indicated by using an indicator field in the first control information.

TABLE 4

| | RO type indicating | |
|---|---|---|
| State | repeated transmission | Description |
| 00 | Uplink sub-band | Repeated transmission uses an RO on an uplink sub-band |
| 01 | Uplink time domain unit | Repeated transmission uses an RO in an uplink time domain |
| | | unit |
| 10 | Uplink time domain unit | Repeated transmission uses two types of ROs, and |
| | and uplink sub-band | repetition is performed in a mode of the uplink time domain |
| | | unit and the uplink sub-band |
| 11 | Uplink sub-band and | Repeated transmission uses two types of ROs, and |
| | uplink time domain unit | repetition is performed in a mode of the uplink sub-band |
| | | and the uplink time domain unit |

In this embodiment of this application, the first RO type includes one group of RO types. The first indication information further indicates a quantity of times of repeated transmission. In some embodiments, the first control information further includes second indication information, and the second indication information is used to indicate a quantity of times of repeated transmission.

It may be understood that when the PDCCH order is used to indicate to perform repeated transmission on a random access preamble for random access, the network side device may indicate the quantity of times of repeated transmission, for example, may perform indication by using a separate indicator field of the quantity of times of repeated transmission (that is, the foregoing second indication information). In some embodiments, as shown in Table 5, the quantity of times of repeated transmission may be indicated together with the RO type used for the repeated transmission.

TABLE 5

| | Quantity of times | RO type indicating | |
|---|---|---|---|
| | of repeated | repeated | |
| State | transmission | transmission | Description |
| 000 | 1 | Uplink sub-band | Transmission is performed once, and an RO on |
| | | | an uplink sub-band is used |
| 001 | 2 | Uplink time domain | Repeated transmission is performed twice, and |
| | | unit | an RO in an uplink time domain unit is used |
| 010 | 4 | Uplink sub-band | Repeated transmission is performed 4 times, and |
| | | | an RO on an uplink sub-band is used |
| . . . | | | |
| 110 | 8 | Uplink time domain | Repeated transmission is performed 8 times, two |
| | | unit and uplink sub- | types of ROs are used, and repetition is |
| | | band | performed in a mode of the uplink time domain |
| | | | unit and the uplink sub-band |
| 111 | 8 | Uplink sub-band | Repeated transmission is performed 8 times, two |
| | | and uplink time | types of ROs are used, and repetition is |
| | | domain unit | performed in a mode of the uplink sub-band and |
| | | | the uplink time domain unit |

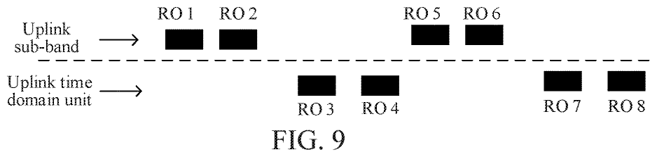

For example, as shown in FIG. 9, it is assumed that a quantity of times of repeated transmission is four, and there may be three cases of the RO type used for repeated transmission. In a case, the RO type used for repeated transmission is two types of RO resources, that is, the RO resource on the uplink sub-band and the RO resource in the uplink time domain unit. For example, RO resources used for repeated transmission performed 4 times are respectively an RO 1 on the uplink sub-band, an RO 2 on the uplink sub-band, an RO 3 in the uplink time domain unit, and an RO 4 in the uplink time domain unit. In another case, the RO type used for repeated transmission is one type of RO resource, that is, the RO resource on the uplink sub-band. For example, RO resources used for repeated transmission performed 4 times are respectively an RO 1 on the uplink sub-band, an RO 2 on the uplink sub-band, an RO 5 on the uplink sub-band, and an RO 6 on the uplink sub-band. In still another case, the RO type used for repeated transmission is one type of RO resource, that is, the RO resource in the uplink time domain unit. For example, RO resources used for repeated transmission performed 4 times are respectively an RO 3 in the uplink time domain unit, an RO 4 in the uplink time domain unit, an RO 7 in the uplink time domain unit, and an RO 8 in the uplink time domain unit.

In this way, the terminal may determine, based on the RO type indicated by the first control information, the RO type used to perform initiation on the random access process or repeated transmission on the preamble. That is, the first control information may explicitly indicate the RO type, to ensure reliability and a resource utilization rate of the terminal performing initiation on the random access process or repeated transmission on the preamble.

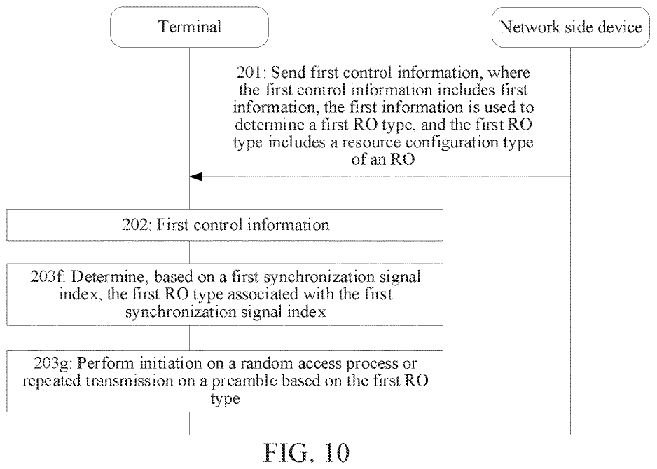

In this embodiment of this application, the first information includes a first synchronization signal index. With reference to FIG. 2, as shown in FIG. 10, step 203 may be implemented by using the following step 203f and step 203g.

Step 203f: The terminal determines, based on the first synchronization signal index, the first RO type associated with the first synchronization signal index.

Step 203g: The terminal performs initiation on the random access process or repeated transmission on the preamble based on the first RO type.

In this embodiment of this application, each synchronization signal index is associated with one RO type, or each synchronization signal index is associated with one group of RO types. The terminal may determine, based on the first synchronization signal index indicated by the first control information, one RO type associated with the first synchronization signal index, to perform initiation on the random access process, or determine one group of RO types associated with the first synchronization signal index, to perform repeated transmission on the preamble.

In this way, the terminal may determine, based on the synchronization signal index indicated by the first control information, the RO type used to perform initiation on the random access process or repeated transmission on the preamble. That is, the first control information may implicitly indicate the RO type, to ensure reliability and a resource utilization rate of the terminal performing initiation on the random access process or repeated transmission on the preamble.

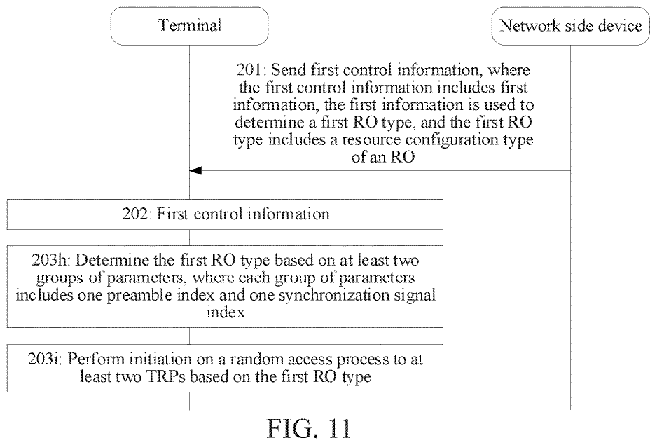

In this embodiment of this application, the first information includes at least two groups of parameters. With reference to FIG. 2, as shown in FIG. 11, step 203 may be implemented by using the following step 203h and step 203i.

Step 203h: The terminal determines the first RO type based on the at least two groups of parameters.

In this embodiment of this application, each group of parameters includes one preamble index and one synchronization signal index.

Step 203i: The terminal performs initiation on a random access process to at least two TRPs based on the first RO type.

In this embodiment of this application, the first RO type includes an RO type associated with each group of parameters. Each of the TRPs corresponds to one group of parameters.

In this embodiment of this application, for a multi-TRP scenario, the network side device may instruct the terminal to perform initiation on random access associated with at least two synchronization signal indexes. A preamble index associated with each synchronization signal index may be indicated.

In this embodiment of this application, each of the at least two groups of parameters corresponds to one indicator field in the first control information. In some embodiments, the at least two groups of parameters each correspond to one indicator field in the first control information.

It may be understood that, for the multi-TRP scenario, a synchronization signal index is indicated to determine an RO type, and a preamble index and a synchronization signal index of each TRP may be indicated by using the preamble index and a synchronization signal index field of each TRP, or preamble indexes and synchronization signal indexes of a plurality of TRPs may be indicated by extending a preamble index and a synchronization signal index field.

For example, in a manner, a related indicator field may be added to the DCI, to indicate at least two groups of parameters. A parameter A is associated with a TRP A, a parameter B is associated with a TRP B, and the rest can be deduced by analogy. The parameter A includes: a random access preamble index A-6 bits; an uplink indication A-1 bit; an SSB index A-6 bits; and a PRACH mask index A-4 bits. The parameter B includes: a random access preamble index B-6 bits; an uplink indication B-1 bit; an SSB index B-6 bits; and a PRACH mask index B-4 bits.

In another manner, a preamble index and a synchronization signal index field (referred to as a first field for short below) may be extended to respectively indicate preamble indexes and synchronization signal indexes of at least two TRPs. For example, a first field indicates 000000, a preamble index of the TRP A is a preamble index A1, an SSB index of the TRP A is an SSB index A1, a preamble index of the TRP B is a preamble index B1, and an SSB index of the TRP B is an SSB index B1. A first field indicates 000001, a preamble index of the TRP A is a preamble index A2, an SSB index of the TRP A is an SSB index A2, a preamble index of the TRP B is a preamble index B2, and an SSB index of the TRP B is an SSB index B2. A first field indicates 111111, a preamble index of the TRP A is a preamble index An, an SSB index of the TRP A is an SSB index An, a preamble index of the TRP B is a preamble index Bn, and an SSB index of the TRP B is an SSB index Bn.

In this way, the terminal may determine, based on the preamble index and the synchronization signal index that are indicated by the first control information, the RO type used to perform initiation on the random access process. That is, the first control information may implicitly indicate the RO type in the multi-TRP scenario, to ensure reliability and a resource utilization rate of the terminal performing initiation on the random access process.

In this embodiment of this application, the terminal does not expect a same RO index to be used for a plurality of RO types associated with one synchronization signal index. It may be understood that, in a case that one synchronization signal index is associated with a plurality of RO types, the network side device may configure different RO indexes/serial numbers of the plurality of RO types, that is, the terminal does not expect one synchronization signal to be mapped to two types of ROs having a same RO index.

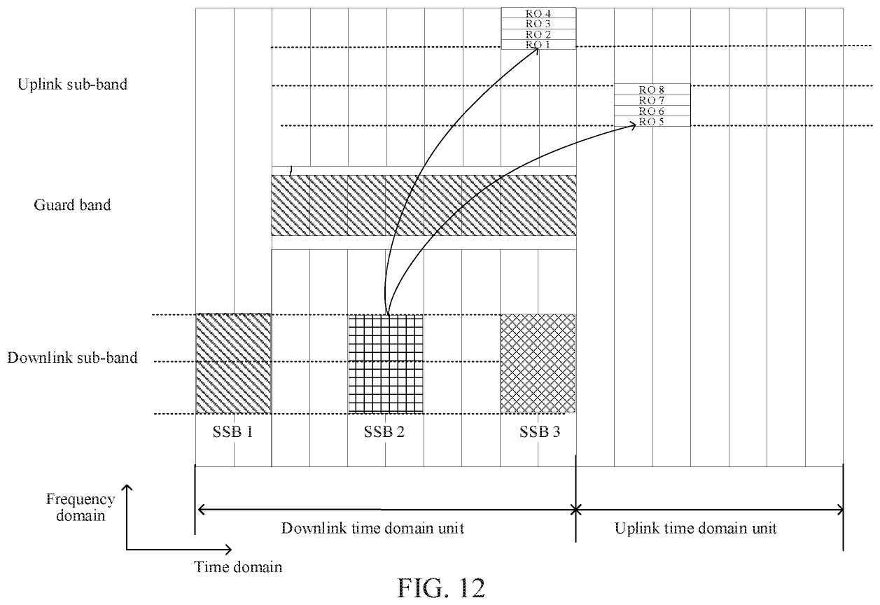

For example, as shown in FIG. 12, assuming that an SSB 2 is associated with/mapped to two types of RO resources, which are respectively an uplink time domain unit and a downlink time domain unit that is configured with an uplink sub-band, the network side device may configure different indexes of the two types of RO resources. For example, RO resources in the uplink time domain unit include an RO 5 to an RO 8, and resources on the uplink sub-band in the downlink time domain unit include an RO 1 to an RO 4. The network side device can determine the RO type by indicating different mask indexes.

For example, the following illustrates a mapping situation from an SSB to an RO:

There may be four time domain unit types for a network side device and a terminal that support Sub-Band Full Duplex (SBFS), including a downlink time domain unit, a downlink time domain unit configured with an uplink sub-band, an uplink time domain unit configured with a downlink sub-band, and an uplink time domain unit.

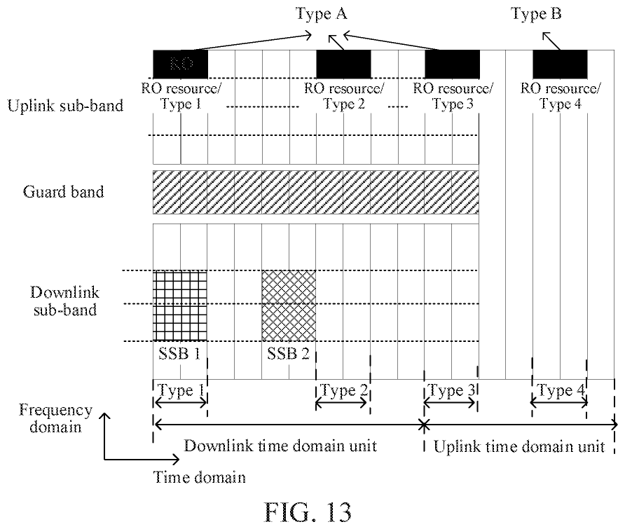

As shown in FIG. 13, there may be two configuration cases for one configured RO resource (PRACH occasions, Physical random-access channel occasions), that is:
Case 1: The RO resource is configured on an uplink sub-band (which may be an uplink symbol, or may be a downlink or flexible symbol), for example, a type A.
Case 2: The RO resource is configured in an uplink time domain unit (no downlink sub-band is configured), for example, a type B, or the RO resource is configured on a resource, in a flexible time domain unit in which only a downlink sub-band is configured, except a downlink sub-band and a guard band.

Further, the configured RO resource may further be divided based on whether the RO resource overlaps an SSB:
(1) A configured RO resource or a type 1: The RO resource is configured on an uplink sub-band in a downlink symbol in which an SSB or a common downlink channel exists, that is, the RO resource overlaps the SSB or the common downlink channel in a time domain. In this case, uplink sending of a terminal interferes with another terminal receiving an SSB, that is, cross-link interference. If the terminal measures or decodes the common downlink channel by using the SSB, self-interference is further received.
(2) A configured RO resource or a type 2: The RO resource is configured on an uplink sub-band in a downlink symbol in which no SSB or no common downlink channel exists, that is, the RO resource does not overlaps the SSB or the common downlink channel in a time domain. In this case, uplink sending of a terminal interferes with another terminal receiving a downlink channel or signal, that is, a PDCCH, a Physical Downlink Shared Channel (PDSCH), a CSI-RS, or the like.
(3) A configured RO resource or a type 3: The RO resource is configured on an uplink sub-band of an uplink symbol, and an interference situation is similar to that of type 2.
(4) A configured RO resource or a type 4: The RO resource is configured on an uplink symbol, and in this case, no cross-link interference exists.

If a Reference Signal Receiving Power (RSRP) of a type of SSB is greater than rsrp-ThresholdSSB, an SSB whose RSRP is greater than rsrp-ThresholdSSB is selected; otherwise, any SSB is selected.

When a CSI-RS is selected, a CSI-RSRP of the CSI-RS is compared with the parameter rsrp-ThresholdSSB. If a CSI-RSRP of a CSI-RS is greater than rsrp-ThresholdCSI-RS, a CSI-RS whose CSI-RSRP is greater than rsrp-ThresholdCSI-RS is selected.

In this embodiment of this application, each beam is associated with one RO type or one group of RO types. The first information includes one piece of indication information (for example, a beam indicator field SpatialRealationInfo). The indication information is used to indicate a target beam used to perform initiation on a random access process or repeated transmission on a preamble. The terminal may determine an RO type associated with the target beam as the first RO type.

In this embodiment of this application, the terminal may obtain a predefined or preconfigured selection rule of the RO type, to perform initiation on a random access process or repeated transmission on the preamble. For example, the terminal preferentially selects an RO resource on a closest uplink sub-band, and then selects an RO resource in an uplink time domain unit.

In this embodiment of this application, the first control information (for example, the PDCCH order carried in the first control information) may further indicate an RO and/or an RO type on a frequency domain unit in a frequency domain unit set. The frequency domain unit may be a bandwidth part (for example, a plurality of uplink bandwidth parts are configured), a carrier or a cell (for example, a primary cell or a secondary cell), or a frequency band or a discrete frequency. This is not limited herein. A frequency domain unit indicator field is required in the PDCCH order, to indicate a specific frequency domain unit (the field may be configured through a network and carried in the PDCCH order), to perform initiation on the random access process or repeated transmission on the preamble.

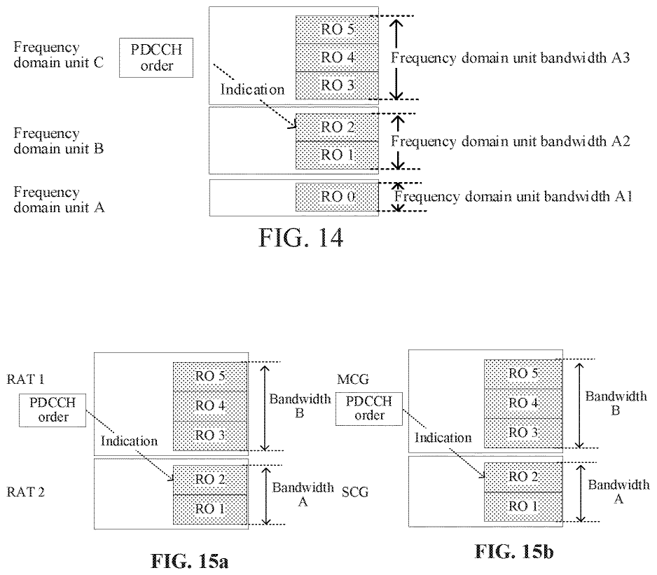

For example, as shown in FIG. 14, an RO configured in a frequency domain unit A is an RO 0, ROs configured in a frequency domain unit B are an RO 1 and an RO 2, ROs configured in a frequency domain unit C are an RO 3, an RO 4, and an RO 5, and a PDCCH order in a frequency domain unit C instructs the terminal to use the RO 2 in the frequency domain unit B.

In this embodiment of this application, the first control information (for example, the PDCCH order carried in the first control information) may further indicate an RO and/or an RO type on at least one Radio Access Technology (RA) (when a dual-connection or a multi-connection is performed through a plurality of RATs), or indicate an RO and/or an RO type on a dual-connection (for example, a primary cell group indicates an RO on a secondary cell group, to trigger random access on the secondary cell group), to perform initiation on a random access process or repeated transmission on a preamble.

For example, as shown in FIG. 15a, ROs configured on a RAT 1 are an RO 3, an RO 4, and an RO 5, ROs configured on the RAT2 are an RO 1 and an RO 2, and a PDCCH order sent on the RAT 1 indicates the ROs on the RAT 2. As shown in FIG. 15b, ROs configured on the primary cell group are an RO 3, an RO 4, and an RO 5, ROs configured on the secondary cell group are an RO 1 and an RO 2, and the PDCCH order is sent on the primary cell group to instruct the terminal to use the ROs on the secondary cell group.

In this embodiment of this application, the first control information (for example, the PDCCH order carried in the first control information) may further indicate one or more ROs and/or RO types in a Timing Advance Group (TAG).

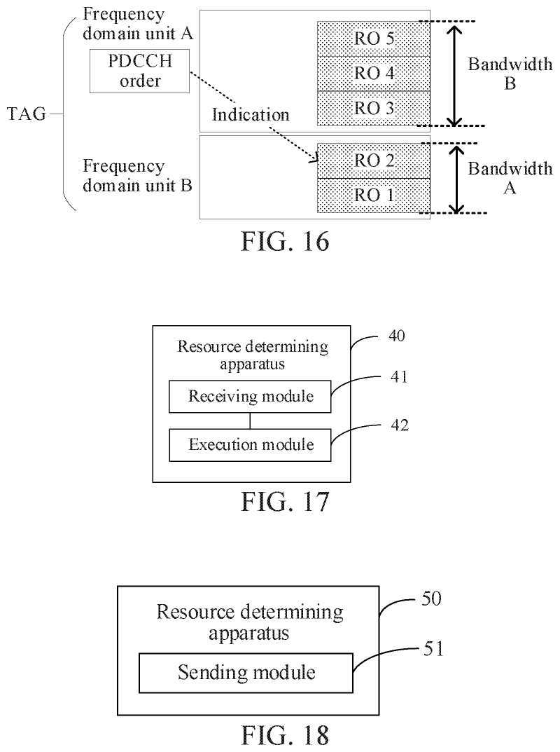

For example, as shown in FIG. 16, the TAG includes a frequency domain unit A and a frequency domain unit B. ROs configured in the frequency domain unit A are an RO 3, an RO 4, and an RO 5, ROs configured in the frequency domain unit B are an RO 1 and an RO 2, and a PDCCH order in the frequency domain unit A instructs the terminal to use the RO 2 in the frequency domain unit B.

This embodiment of this application provides a resource determining method. The terminal receives the first control information from the network side device, where the first control information includes the first information, and the first information is used to determine the RO type used to perform initiation on the random access process or repeated transmission on the preamble. The terminal performs initiation on the random access process or repeated transmission on the preamble based on the first RO type. In this solution, the terminal may determine, based on the first information in the first control information, the RO type used to perform initiation on the random access process or repeated transmission on the preamble. That is, the first control information may explicitly or implicitly indicate the RO type, so that the terminal learns the specific RO type used when initiation on the random access process is performed or repeated transmission on the preamble is performed, thereby ensuring reliability and a resource utilization rate of the terminal performing initiation on the random access process or repeated transmission on the preamble.

The foregoing method embodiments or various possible implementations of the method embodiments may be separately performed, or any two or more may be performed in combination with each other. The method embodiments or the possible implementations may be determined based on an actual use requirement, which is not limited in embodiments of this application.

For the resource determining method provided in the embodiments of this application, an execution body may be a resource determining apparatus. In the embodiments of this application, an example in which the resource determining apparatus executes the resource determining method is used to describe the resource determining apparatus provided in the embodiments of this application.

FIG. 17 is an exemplary schematic diagram of a structure of a resource determining apparatus used in an embodiment of this application. As shown in FIG. 17, the resource determining apparatus 40 may include a receiving module 41 and an execution module 42.

The receiving module 41 is configured to receive first control information from a network side device, where the first control information includes first information, the first information is used to determine a first RO type, and the first RO type includes a resource configuration type of an RO. The execution module 42 is configured to perform initiation on a random access process or repeated transmission on a preamble based on the first RO type.

In an implementation, the first information includes a first mask value index; and the execution module 41 is configured to:
determine, based on the first mask value index, the first RO type corresponding to the first mask value index, where each mask value index corresponds to one RO type or one group of RO types; and
perform initiation on a random access process or repeated transmission on a preamble based on the first RO type.

In an implementation, the first information includes a time interval; and the execution module 41 is configured to:
determine the first RO type based on the time interval, where the time interval is a time interval from a last symbol used by the first control information to a time domain unit of the RO, and a time interval range within which each time interval falls has an association relationship with an RO type; and
perform initiation on a random access process or repeated transmission on a preamble based on the first RO type.

In an implementation, the first information further includes an initial RO symbol; and the foregoing execution module 41 is configured to: in a case that one time domain unit includes a plurality of RO types, determine the first RO type based on the time interval and the initial RO symbol.

In an implementation, the first information includes first indication information; and the foregoing execution module 41 is configured to perform initiation on the random access process or repeated transmission on the preamble based on the first RO type indicated by the first indication information.

In an implementation, the first RO type includes one group of RO types. The first indication information further indicates a quantity of times of repeated transmission. In some embodiments, the first control information further includes second indication information, and the second indication information is used to indicate a quantity of times of repeated transmission.

In an implementation, when the one group of RO types includes at least one of the following: an RO resource on an uplink sub-band or an RO resource in a first time domain unit; and the first time domain unit is an uplink time domain unit or a flexible time domain unit.

In an implementation, the first information includes a first synchronization signal index; and the execution module 41 is configured to:
determine, based on the first synchronization signal index, the first RO type associated with the first synchronization signal index; and
perform initiation on a random access process or repeated transmission on a preamble based on the first RO type.

In an implementation, the first information includes at least two groups of parameters, and each group of parameters includes one preamble index and one synchronization signal index; and the execution module 41 is configured to:
determine the first RO type based on the at least two groups of parameters, where the first RO type includes an RO type associated with each group of parameters; and
perform initiation on the random access process to at least two transmission and reception points TRP based on the first RO type, where each of the TRPs corresponds to one group of parameters.

In an implementation, each of the at least two groups of parameters corresponds to one indicator field in the first control information; or
the at least two groups of parameters each correspond to one indicator field in the first control information.

In an implementation, the terminal does not expect a same RO index to be used for a plurality of RO types associated with one synchronization signal index.

This embodiment of this application provides a resource determining apparatus. The resource determining apparatus may determine, based on the first information in the first control information, the RO type used to perform initiation on the random access process or repeated transmission on the preamble. That is, the first control information may explicitly or implicitly indicate the RO type, so that the resource determining apparatus learns the specific RO type used when initiation on the random access process is performed or repeated transmission on the preamble is performed, thereby ensuring reliability and a resource utilization rate of the resource determining apparatus performing initiation on the random access process or repeated transmission on the preamble.

The resource determining apparatus in this embodiment of this application may be an electronic device, for example, an electronic device with an operating system, or may be a component in an electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The resource determining apparatus provided in the embodiments of this application can implement the processes implemented in the foregoing resource determining method embodiments, and achieve a same technical effect. To avoid repetition, details are not described herein again.

FIG. 18 is an exemplary schematic diagram of a structure of a resource determining apparatus used in an embodiment of this application. As shown in FIG. 18, the resource determining apparatus 50 may include a sending module 51.

The sending module 51 is configured to send first control information to a terminal, where the first control information includes first information, the first information is used to determine a first RO type, the first RO type includes a resource configuration type of an RO, and the first RO type is used to perform initiation on a random access process or repeated transmission on a preamble.

In an implementation, the first information includes a first mask value index, the first mask value index is used to determine the first RO type corresponding to the first mask value index, and each mask value index corresponds to one RO type or one group of RO types.

In an implementation, the first information includes a time interval, the time interval is used to determine the first RO type, the time interval is a time interval from a last symbol used by the first control information to a time domain unit of the RO, and a time interval range within which each time interval falls has an association relationship with an RO type.

In an implementation, the first information includes first indication information, and the first indication information is used to indicate the first RO type.

In an implementation, the first information includes a first synchronization signal index, and the first synchronization signal index is used to determine the first RO type associated with the first synchronization signal index.

In an implementation, the first information includes at least two groups of parameters, each group of parameters includes one preamble index and one synchronization signal index, the at least two groups of parameters are used to determine the first RO type, and the first RO type includes an RO type associated with each group of parameters.

This embodiment of this application provides a resource determining apparatus. The resource determining apparatus may send the first information to the terminal based on the first control information, so that the terminal determines the RO type used to perform initiation on the random access process or repeated transmission on the preamble. That is, the first control information may explicitly or implicitly indicate the RO type, so that the terminal learns the specific RO type used when initiation on the random access process is performed or repeated transmission on the preamble is performed, thereby ensuring reliability and a resource utilization rate of the terminal performing initiation on the random access process or repeated transmission on the preamble.

The resource determining apparatus provided in the embodiments of this application can implement the processes implemented in the foregoing resource determining method embodiments, and achieve a same technical effect. To avoid repetition, details are not described herein again.

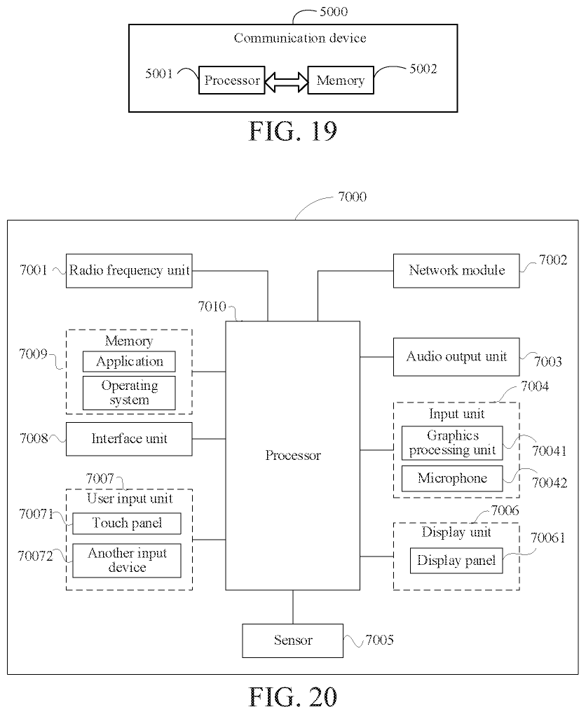

As shown in FIG. 19, an embodiment of this application further provides a communication device 5000, including a processor 5001 and a memory 5002. The memory 5002 stores a program or instructions runnable on the processor 5001. For example, when the communication device 5000 is the terminal, the program or the instructions, when executed by the processor 5001, implement the steps of the terminal side method embodiments, and can achieve the same technical effect. To avoid repetition, details are not described herein again. When the communication device 5000 is a network side device, the program or instructions implement various steps of the foregoing network side device method when executed by the processor 5001 and can achieve the same technical effects. To avoid repetition, details are not described herein again.

An embodiment of this application further provides a terminal, including a processor and a communication interface. The communication interface is coupled to the processor, and the processor is configured to run a program or instructions, to implement the steps of the foregoing resource determining method embodiments. The terminal embodiment corresponds to the terminal side method embodiment, each implementation process and implementation of the method embodiment can be applied to the terminal embodiment, and a same technical effect can be achieved. FIG. 20 is a schematic diagram of a hardware structure of a terminal according to an embodiment of this application.

The terminal 7000 includes but is not limited to at least some of components such as a radio frequency unit 7001, a network module 7002, an audio output unit 7003, an input unit 7004, a sensor 7005, a display unit 7006, a user input unit 7007, an interface unit 7008, a memory 7009, and a processor 7010.

A person skilled in the art may understand that the terminal 7000 may further include a power supply (such as a battery) for supplying power to the components. The power supply may be logically connected to the processor 7010 by a power management system, thereby implementing functions such as charging, discharging, and power consumption management by using the power management system. The terminal structure shown in FIG. 20 does not impose a limitation on the terminal. The terminal may include more or fewer components than those shown in the figure, or combine some components, or adopt different component arrangements. Details are not described herein again.

It should be understood that in this embodiment of this application, the input unit 7004 may include a Graphics Processing Unit (GPU) 70041 and a microphone 70042. The graphics processing unit 70041 processes image data of a static picture or a video obtained by an image capture apparatus (for example, a camera) in a video capture mode or an image capture mode. The display unit 7006 may include a display panel 70061, which can be configured in a form of a liquid crystal display, an organic light-emitting diode, or the like. The user input unit 7007 includes at least one of a touch panel 70071 or another input device 70072. The touch panel 70071 is also referred to as a touchscreen. The touch panel 70071 may include two parts: a touch detection apparatus and a touch controller. The another input device 70072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 7001 may transmit the downlink data to the processor 7010 for processing. In addition, the radio frequency unit 7001 may send uplink data to a network side device. Usually, the radio frequency unit 7001 includes but is not limited to an antenna, an amplifier, a transceiver, a coupler, a low noise amplifier, a duplexer, and the like.

The memory 7009 may be configured to store a software program or an instruction and various data. The memory 7009 may mainly include a first storage area for storing a program or instructions and a second storage area for storing data. The first storage area may store an operating system, and an application program or an instruction required by at least one function (for example, a sound playing function or an image playing function). In addition, the memory 7009 may include a volatile memory or non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 7009 in this embodiment of this application includes, but is not limited to, these memories and any other suitable types of memories.

The processor 7010 may include one or more processing units. In some embodiments, an application processor and a modem processor are integrated into the processor 7010, the application processor mainly processes operations related to an operating system, a user interface, an application program, and the like, and the modem processor mainly processes a wireless communication signal, for example, a baseband processor. It may be understood that the foregoing modem may not be integrated into the processor 7010.

The terminal provided in this embodiment of this application can implement the processes implemented in the foregoing method embodiments and achieve a same technical effect. For implementation processes of the implementations mentioned in this embodiment, refer to related descriptions in the foregoing resource determining method embodiments. To avoid repetition, details are not described herein again.

An embodiment of this application further provides a network side device, including a processor and a communication interface. The communication interface is coupled to the processor, and the processor is configured to run a program or instructions, to implement the steps of the foregoing resource determining method embodiments. The network side device embodiment corresponds to the foregoing method embodiment of the network side device. Each implementation process and implementation of the foregoing method embodiment may be applicable to this network side device embodiment, and a same technical effect can be achieved.

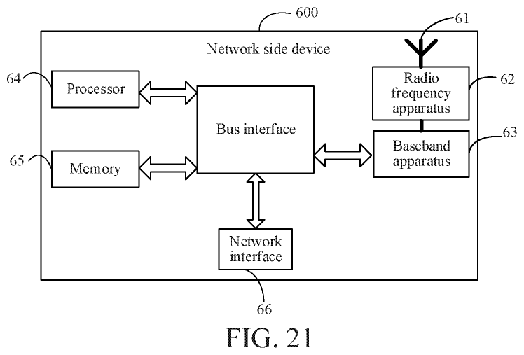

An embodiment of this application further provides a network side device. As shown in FIG. 21, the network side device 600 includes: an antenna 61, a radio frequency apparatus 62, a baseband apparatus 63, a processor 64, and a memory 65. The antenna 61 is connected to the radio frequency apparatus 62. In an uplink direction, the radio frequency apparatus 62 receives information through the antenna 61 and sends the received information to the baseband apparatus 63 for processing. In a downlink direction, the baseband apparatus 63 processes information that needs to be sent, and sends processed information to the radio frequency apparatus 62. The radio frequency apparatus 62 processes the received information, and then sends processed information through the antenna 61.

In the foregoing embodiment, the method executed by the network side device may be implemented in the baseband apparatus 63. The baseband apparatus 63 includes a baseband processor.

For example, the baseband apparatus 63 may include at least one baseband board. A plurality of chips are disposed on the baseband board. As shown in FIG. 21, one chip is, for example, a baseband processor, and is connected to the memory 65 by using a bus interface, to invoke a program in the memory 65, to perform the operations of the network device shown in the foregoing method embodiment.

The network side device may further include a network interface 66, and the interface, for example, is a Common Public Radio Interface (CPRI).

The network side device 600 in this embodiment of this application further includes: instructions or a program stored in the memory 65 and runnable on the processor 64. The processor 64 invokes the instructions or the program stored in the memory 65 to perform the method performed by each module shown in the resource determining apparatus, and a same technical effect is achieved. To avoid repetition, this is not described herein again.

An embodiment of this application further provides a readable storage medium. The readable storage medium stores a program or instructions. When the program or the instructions are executed by a processor, the processes of the resource determining method embodiment are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or instructions, to implement the processes of the resource determining method embodiment, and a same technical effect can be achieved. To avoid repetition, details are not described herein again.

It should be understood that the chip mentioned in this embodiment of this application may be referred to as a system on chip, a system chip, a system on a chip, or a system-on-a-chip, or the like.

An embodiment of this application further provides a computer program/a program product, stored in a storage medium. The computer program/the program product is executed by at least one processor to implement processes of the foregoing resource determining method embodiment, and achieves a same technical effect. To avoid repetition, details are not described herein again.

An embodiment of this application further provides a wireless communication system, including a terminal and a network side device. The terminal may be configured to perform the steps of the foregoing resource determining method. The network side device may be configured to perform the steps of the foregoing resource determining method.

It should be noted that, the terms “include”, “comprise”, or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, elements defined by the sentence “including one” does not exclude that there are still other same elements in the processes, methods, objects, or apparatuses. In addition, it should be noted that the scope of the method and apparatus in the embodiments of this application is not limited to performing functions in an order shown or discussed, and may further include performing functions in a basically simultaneous manner or in a reverse order according to related functions. For example, the described method may be performed in an order different from the described order, and various steps may be added, omitted, or combined. In addition, features described with reference to some examples may be combined in other examples.

According to the descriptions of the foregoing implementations, a person skilled in the art may clearly understand that the method in the foregoing embodiments may be implemented by using a computer software product and a necessary universal hardware platform, or may be implemented by using hardware. The computer software product is stored in a storage medium (for example, a ROM, a RAM, a magnetic disk, or an optical disc), and includes several instructions, to enable a terminal or a network side device to perform the methods described in the embodiments of this application.

The foregoing describes the embodiments of this application with reference to the accompanying drawings. However, this application is not limited to the foregoing specific implementations. The foregoing specific implementations are merely examples, but are not limitative. Inspired by this application, a person of ordinary skill in the art may further make implementations in many forms without departing from the purposes of this application and the protection scope of the claims, and all the implementations shall fall within the protection of this application.

What is claimed is:

1. A method for resource determining, comprising:
receiving, by a terminal, first control information from a network side device, wherein the first control information comprises first information, the first information is used to determine a first random access channel occasion (RO) type, and the first RO type comprises a resource configuration type of an RO; and
performing, by the terminal, initiation on a random access process based on the first RO type.

2. The method according to claim 1, wherein the resource configuration type of the RO comprises any one of the following:
an RO resource on an uplink sub-band;
an RO resource in an uplink time domain unit;
an RO resource in a flexible time domain unit; or
an RO resource spanning a plurality of resources.

3. The method according to claim 1, wherein the first information comprises a first mask value index; and the performing, by the terminal, initiation on a random access process based on the first RO type comprises:
determining, by the terminal based on the first mask value index, the first RO type corresponding to the first mask value index, wherein each mask value index corresponds to one RO type or one group of RO types; and
performing, by the terminal, initiation on the random access process based on the first RO type.

4. The method according to claim 1, wherein the first information comprises a time interval; and the performing, by the terminal, initiation on a random access process based on the first RO type comprises:
determining, by the terminal, the first RO type based on the time interval, wherein the time interval is a time interval from a last symbol used by the first control information to a time domain unit of the RO, and a time interval range within which each time interval falls has an association relationship with an RO type; and
performing, by the terminal, initiation on the random access process based on the first RO type.

5. The method according to claim 4, wherein the first information further comprises an initial RO symbol; and the determining, by the terminal, the first RO type based on the time interval comprises:
when one time domain unit comprises a plurality of RO types, determining, by the terminal, the first RO type based on the time interval and the initial RO symbol.

6. The method according to claim 1, wherein the first information comprises first indication information; and the performing, by the terminal, initiation on a random access process based on the first RO type comprises:
performing, by the terminal, initiation on the random access process based on the first RO type indicated by the first indication information.

7. The method according to claim 6, wherein the first RO type comprises one group of RO types; and
the first indication information further indicates a quantity of times of repeated transmission; or
the first control information further comprises second indication information, and the second indication information is used to indicate a quantity of times of repeated transmission.

8. The method according to claim 3, wherein the one group of RO types comprises at least one of the following: an RO resource on an uplink sub-band or an RO resource in a first time domain unit; and the first time domain unit is an uplink time domain unit or a flexible time domain unit.

9. The method according to claim 1, wherein the first information comprises a first synchronization signal index; and the performing, by the terminal, initiation on a random access process based on the first RO type comprises:
determining, by the terminal based on the first synchronization signal index, the first RO type associated with the first synchronization signal index; and
performing, by the terminal, initiation on the random access process based on the first RO type.

10. The method according to claim 1, wherein the first information comprises at least two groups of parameters, and each group of parameters comprises one preamble index and one synchronization signal index; and the performing, by the terminal, initiation on a random access process based on the first RO type comprises:
determining, by the terminal, the first RO type based on the at least two groups of parameters, wherein the first RO type comprises an RO type associated with each group of parameters; and
performing, by the terminal, initiation on the random access process to at least two transmission and reception points (TRPs) based on the first RO type, wherein each of the TRPs corresponds to one group of parameters.

11. The method according to claim 10, wherein each of the at least two groups of parameters corresponds to one indicator field in the first control information; or
the at least two groups of parameters each correspond to one indicator field in the first control information.

12. The method according to claim 9, wherein the terminal does not expect a same RO index to be used for a plurality of RO types associated with one synchronization signal index.

13. A method for resource determining, comprising:
sending, by a network side device, first control information to a terminal, wherein the first control information comprises first information, the first information is used to determine a first random access channel occasion (RO) type, the first RO type comprises a resource configuration type of an RO, and the first RO type is used to perform initiation on a random access process.

14. The method according to claim 13, wherein the resource configuration type of the RO comprises any one of the following:
an RO resource on an uplink sub-band;
an RO resource in an uplink time domain unit;
an RO resource in a flexible time domain unit; or
an RO resource spanning a plurality of resources.

15. The method according to claim 13, wherein the first information comprises a first mask value index, the first mask value index is used to determine the first RO type corresponding to the first mask value index, and each mask value index corresponds to one RO type or one group of RO types.

16. The method according to claim 13, wherein the first information comprises a time interval, the time interval is used to determine the first RO type, the time interval is a time interval from a last symbol used by the first control information to a time domain unit of the RO, and a time interval range within which each time interval falls has an association relationship with an RO type.

17. The method according to claim 13, wherein the first information comprises first indication information, and the first indication information is used to indicate the first RO type.

18. The method according to claim 13, wherein the first information comprises a first synchronization signal index, and the first synchronization signal index is used to determine the first RO type associated with the first synchronization signal index.

19. The method according to claim 13, wherein the first information comprises at least two groups of parameters, each group of parameters comprises one preamble index and one synchronization signal index, the at least two groups of parameters are used to determine the first RO type, and the first RO type comprises an RO type associated with each group of parameters.

20. A terminal, comprising: a memory storing a computer program; and a processor coupled to the memory and configured to execute the computer program to perform operations comprising:
receiving first control information from a network side device, wherein the first control information comprises first information, the first information is used to determine a first random access channel occasion (RO) type, and the first RO type comprises a resource configuration type of an RO; and
performing initiation on a random access process based on the first RO type.
